(19) United States
(12) Patent Application Publication
(10) Pub. No.: US 2004/0172379 A1
(43) Pub. Date: Sep. 2, 2004

(54) Method, system and apparatus for acquiring data from a database

(76) Inventors: Elyse Mott, Lawrenceville, GA (US); Heather N. Stevens, Marietta, GA (US); Stacy L. Dueitt, Hoover, AL (US)

Correspondence Address: Philmore H. Colburn II, Cantor Colburn LLP, 55 Griffin Road South, Bloomfield, CT, 06002, US

(21) Appl. No.: 10/769,945

(22) Filed: Feb. 2, 2004

Related U.S. Application Data
(60) Provisional application No. 60/450,369, filed on Feb. 27, 2003.

(51) Int. Cl. G06F 17/30

(52) U.S. Cl. 707/1

(57) ABSTRACT

A computer program product includes a storage medium, readable by a processing circuit, storing instructions for execution by the processing circuit for: responding to user access information for accessing data at a database, responding to a product identifier relating to the data at the database, and responding to a command for accessing the database for data relating to the product identifier; accessing and retrieving from the database data relating to the product identifier; responding to a command for generating a presentation in one of at least two pre-defined formats; and, displaying the retrieved data in the one of at least two pre-defined formats and in a finished form.

### CROSS REFERENCE TO RELATED APPLICATIONS

This application claims, under 35 U.S.C. §119, the benefit of U.S. Provisional Application Serial No. 60/450,369, filed Feb. 27, 2003, which is incorporated herein by reference in its entirety.

### FIELD OF THE INVENTION

The present disclosure relates generally to the acquisition of data from a database, and particularly to the creation of a presentation of data from a centralized database containing relevant account and marketing data, the presentation being generated in a predefined format.

### BACKGROUND OF THE INVENTION

Sales representatives being responsible for many sales accounts in multiple regions and within a local market are faced with the challenge of selling similar products in different geographical regions or headings that may have substantially different data and demographics. In response to the differences faced by the sales representative, the typical sales presentation takes on a local style that is uniquely tailored for that particular heading and geographic region. As a result, multiple presentations are created, which may or may not be saved for subsequent use, with the end result being a large database of sales account presentations, upwards of tens of thousands, that may or may not contain obsolete data. Since the sales representative needs to provide a presentation containing data that is contemporaneous with the existing market conditions, much time is expended either searching for the appropriate presentation saved to the database, or creating a new presentation. Accordingly, it would be beneficial to have a more efficient and effective way of creating a presentation that can present similar but factually different data relating to geographically different audiences.

### SUMMARY OF THE INVENTION

Embodiments disclosed herein provide a computer program product having a storage medium, readable by a processing circuit, storing instructions for execution by the processing circuit for: responding to user access information for accessing data at a database, responding to a product identifier relating to the data at the database, and responding to a command for accessing the database for data relating to the product identifier; accessing and retrieving from the database, data relating to the product identifier; responding to a command for generating a presentation in one of at least two pre-defined formats; and displaying the retrieved data in the one of at least two pre-defined formats and in a finished form.

Further embodiments disclosed herein provide a method for acquiring data from a database. The method is responsive to user access information for accessing data at a database, a product identifier relating to the data at the database, and a command for accessing the database for data relating to the product identifier. The method accesses and retrieves from the database and via the Internet, data relating to the product identifier, responds to a command for generating a presentation in one of at least two pre-defined formats, and displays the retrieved data in the one of at least two pre-defined formats and in a finished form.

### BRIEF DESCRIPTION OF THE DRAWINGS

Referring to the exemplary drawings wherein like elements are numbered alike in the accompanying Figures:

FIG. 1 is an exemplary method for accessing data from a database in accordance with an embodiment of the invention;

FIG. 2 is an exemplary system for implementing the method of FIG. 1;

FIGS. 3A-3E are an expansion of the method of FIG. 1;

FIGS. 4A-4N depict an exemplary outcome of the method of FIG. 1;

FIG. 5A-5E depict an alternative exemplary outcome of the method of FIG. 1; and

FIG. 6 depicts a flow diagram in relation to the method of FIG. 1.

### DETAILED DESCRIPTION OF THE INVENTION

Embodiments of the invention disclosed herein provide a standard way for a sales representative to prepare an account or to create a presentation for a client from a database of market information (data). While embodiments disclosed herein depict market data as exemplary data within the database, it will be appreciated that the disclosed invention is also applicable to other types of data, such as personal or technical data for example. Also, while embodiments disclosed herein depict exemplary data, it will be appreciated that such data is illustrative only, may not be representative of factual data, and is not intended to be relied upon for any factual content. Furthermore, all Trademarks, or illustrations representative of Trademarks, contained herein are the property of their respective owners, and it will be appreciated that the depiction of any Trademark is for exemplary purposes only, and that a source identifier for other products or services may be substituted therefore.

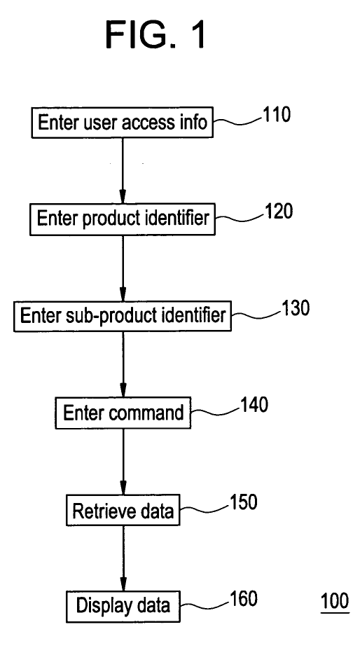

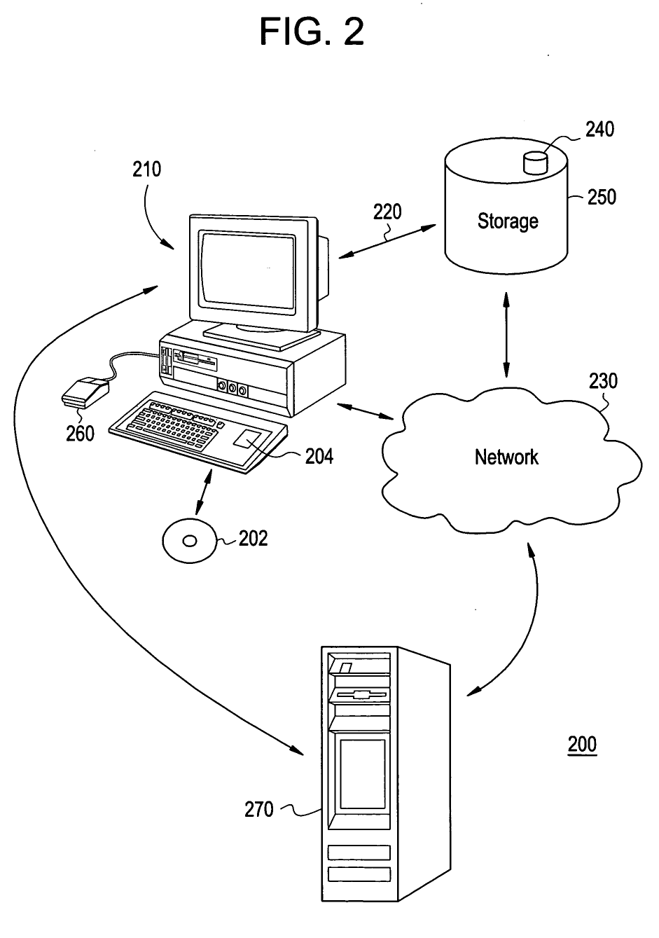

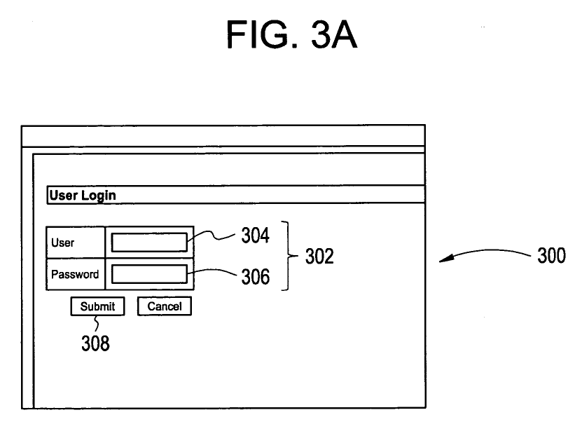

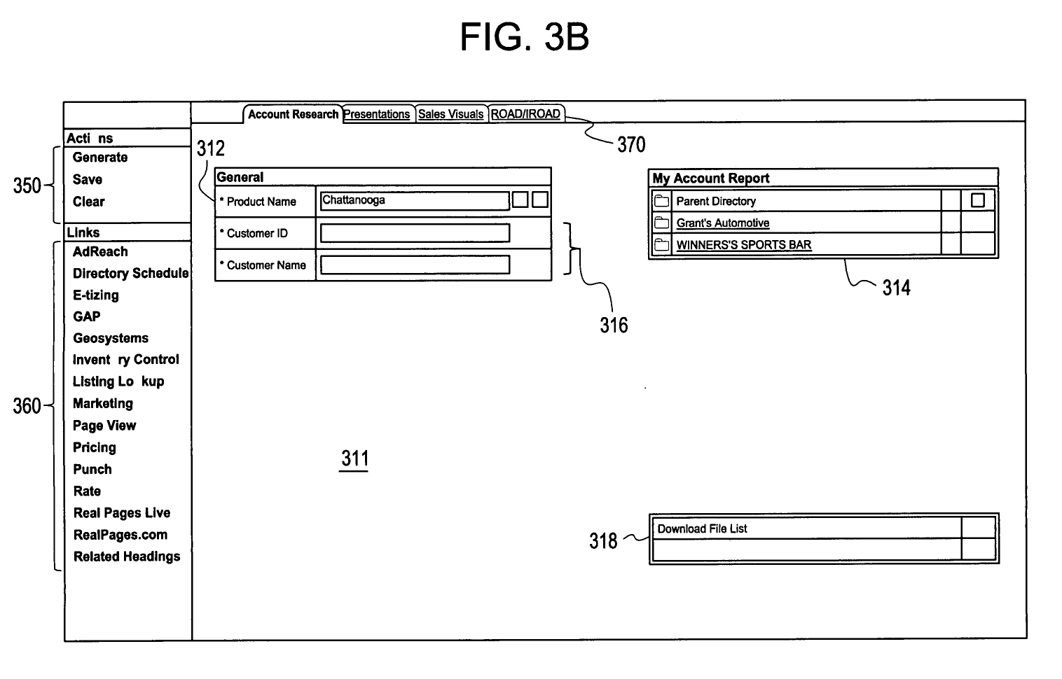

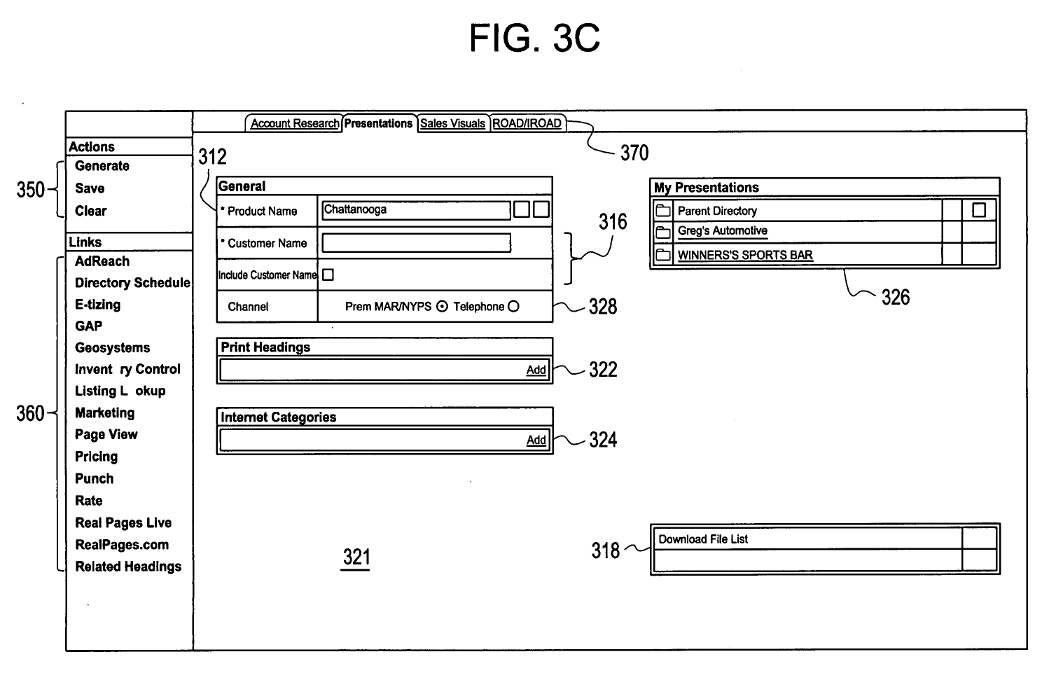

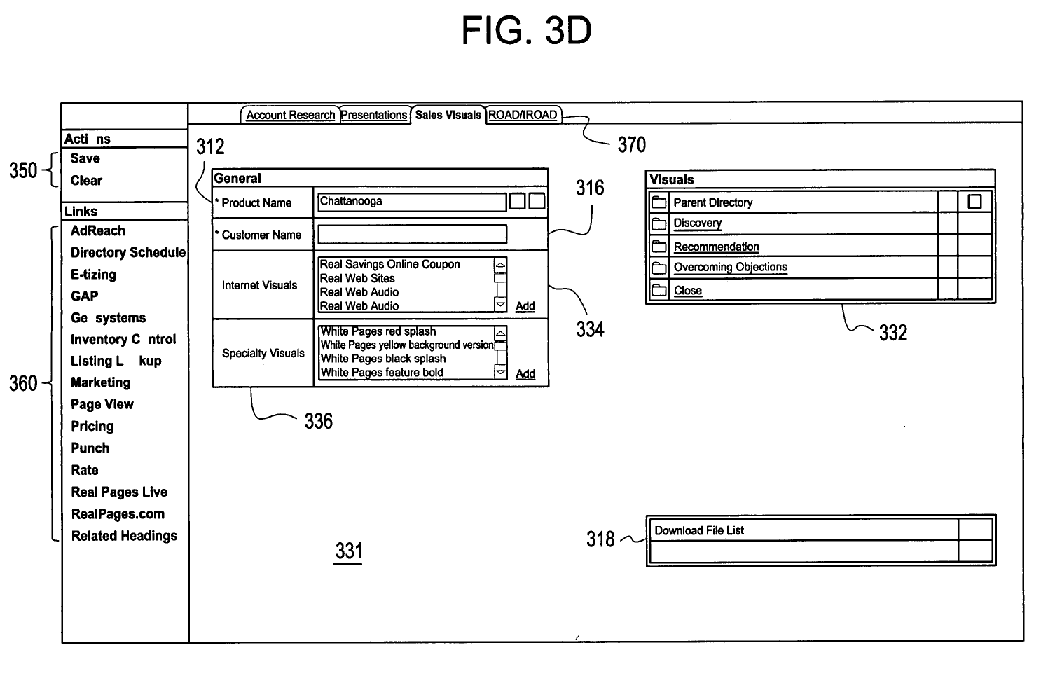

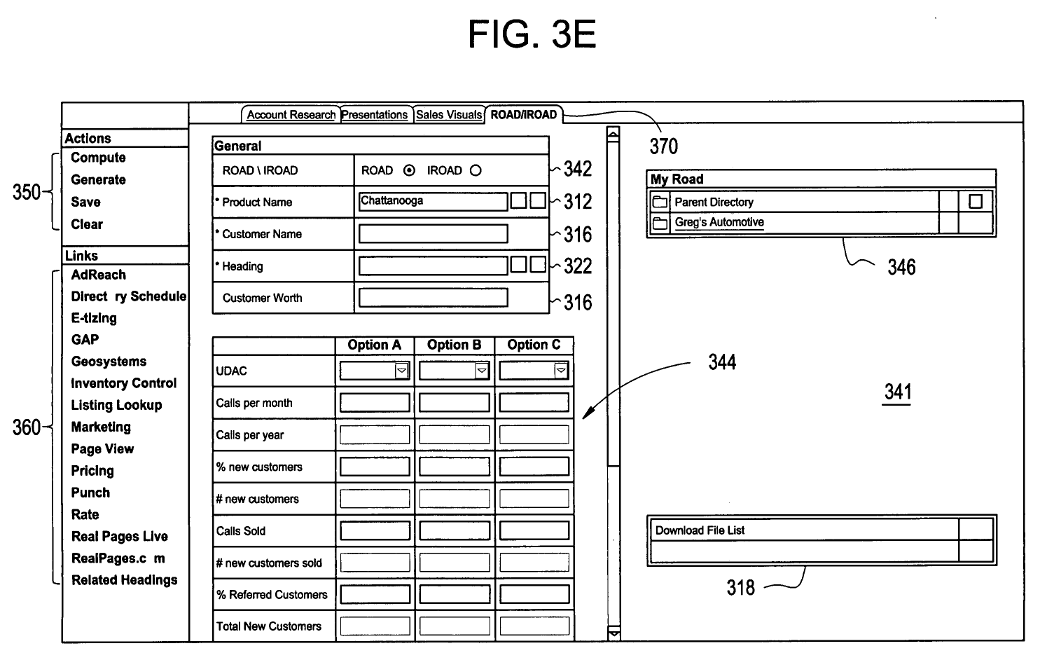

FIG. 1 is an exemplary embodiment of a method 100 for acquiring and displaying proprietary data from a database, FIG. 2 is an exemplary computer system 200 for implementing method 100, and FIGS. 3A-3E depict an exemplary method 300 for providing user input to computer system 200. In an embodiment, the proprietary data is sales or marketing data, not generally publicly available data, that is provided by a service provider who is compensated for the service. However, non-proprietary data may be incorporated with the proprietary data. In an embodiment, computer system 200 is an interconnected system, via a physical connection 220 or a network connection 230 (such as the Internet, Intranet, or VPN (virtual private network), for example), of computers (denoted by a single computer 210 (desktop, laptop, handheld or other), but it will be recognized that there may be more than one computer 210) having access to a storage device 250 wherein resides a database 240. A pointing device 260 (recognized as a mouse, but may be any pointing device usable with computer 210) may also be provided for ease of user input. Internet 230 denotes communication, cable or wireless, with any shared computer resource. Storage device 250 may be a standalone device, a shared network device, or integrated in computer 210. In an embodiment, method 300 is implemented by a user entering predefined information into graphic screens of computer system 200, as will be discussed in detail below.

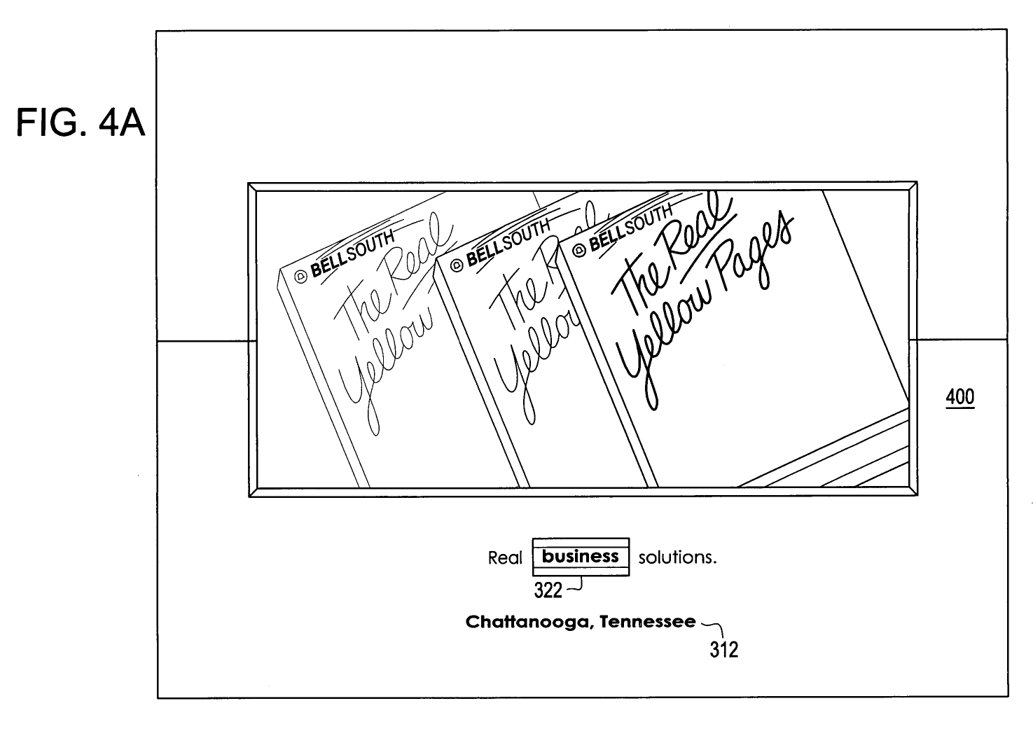

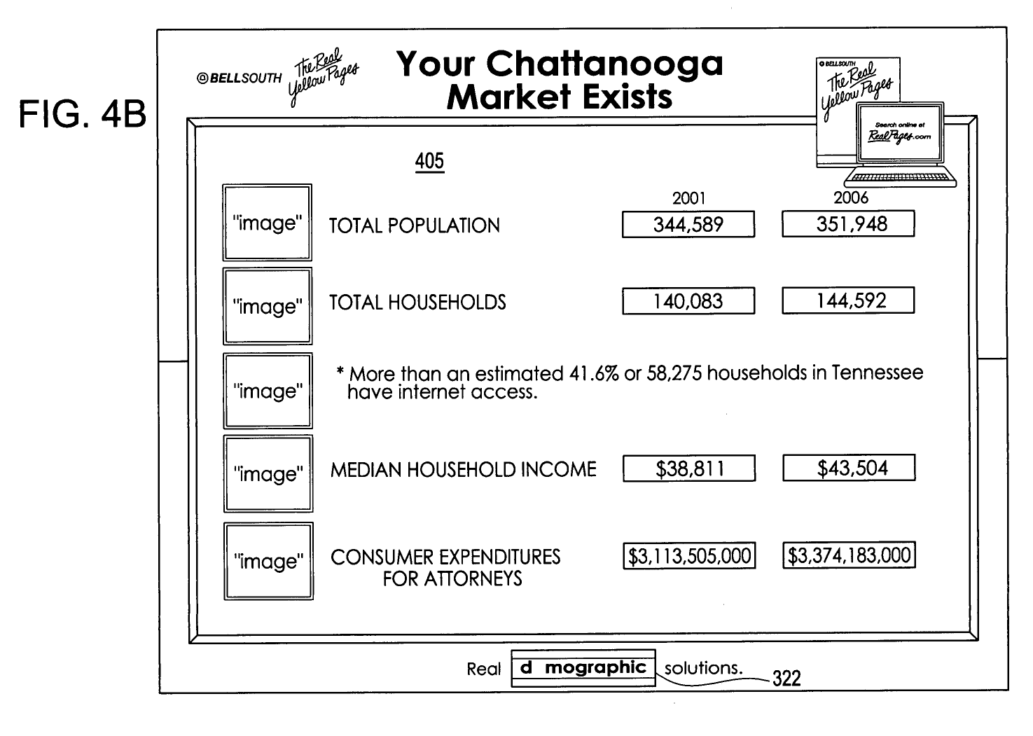

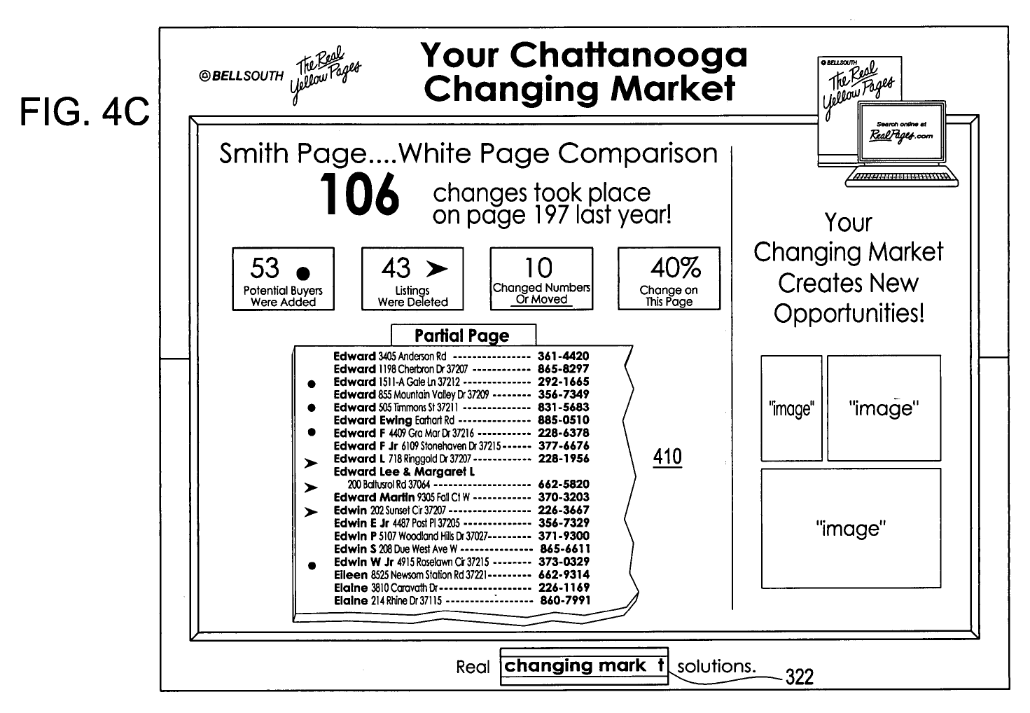

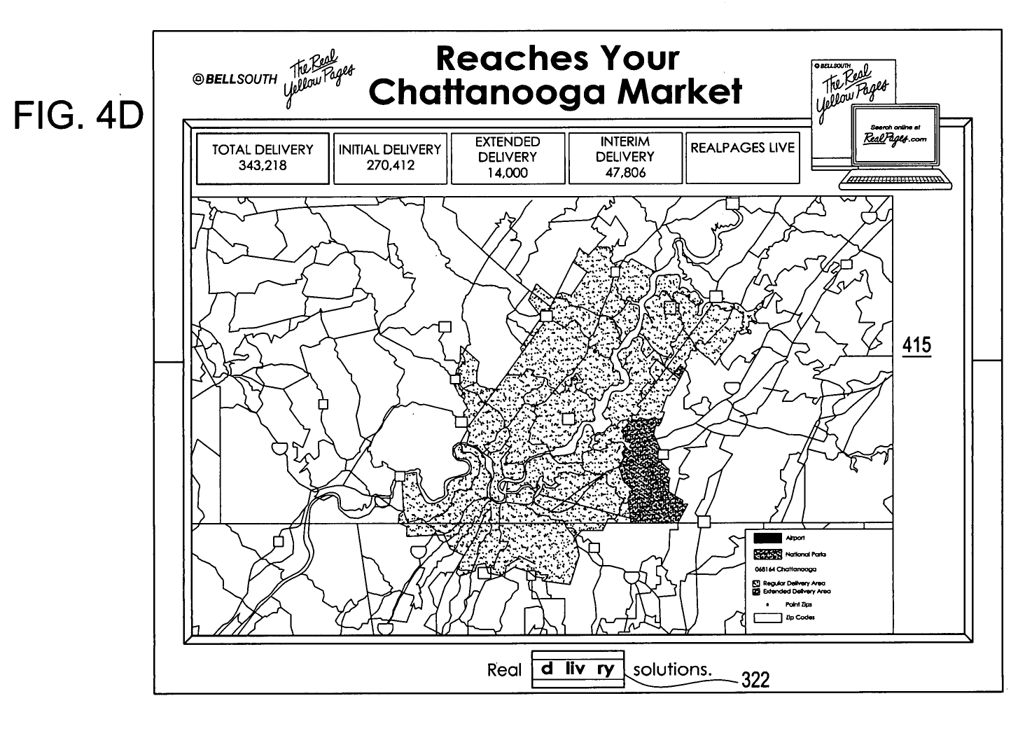

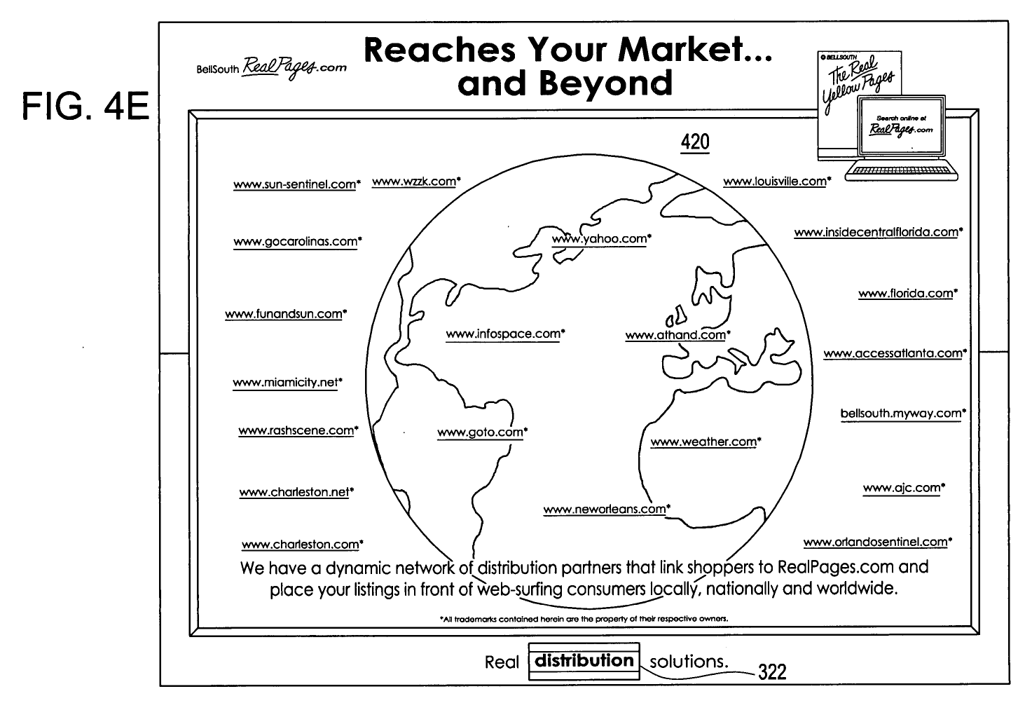

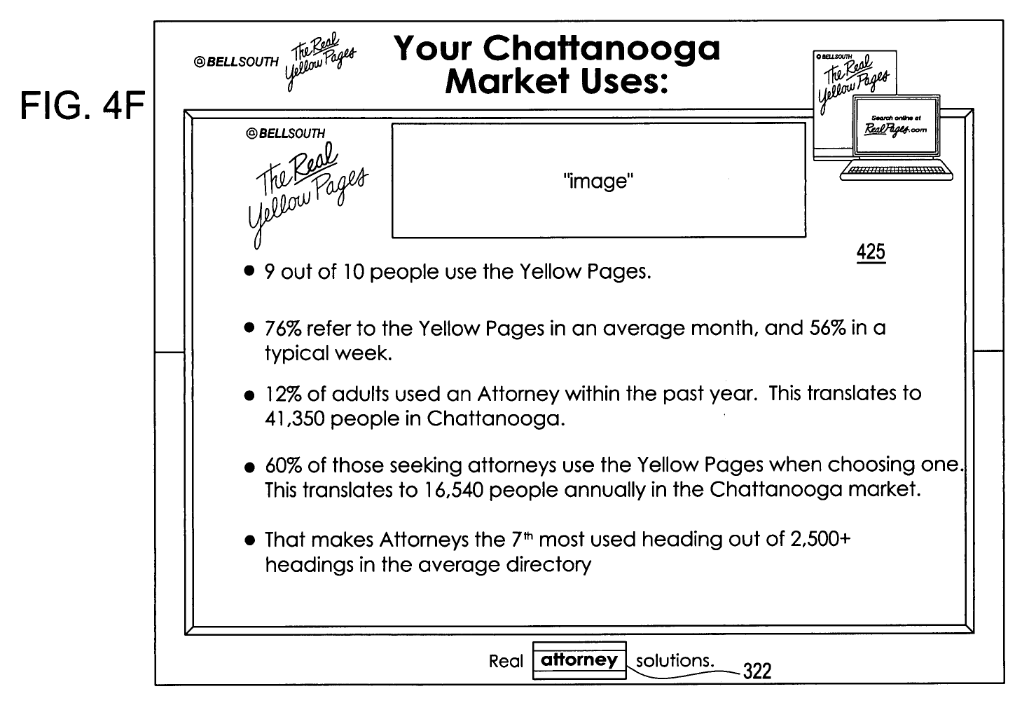

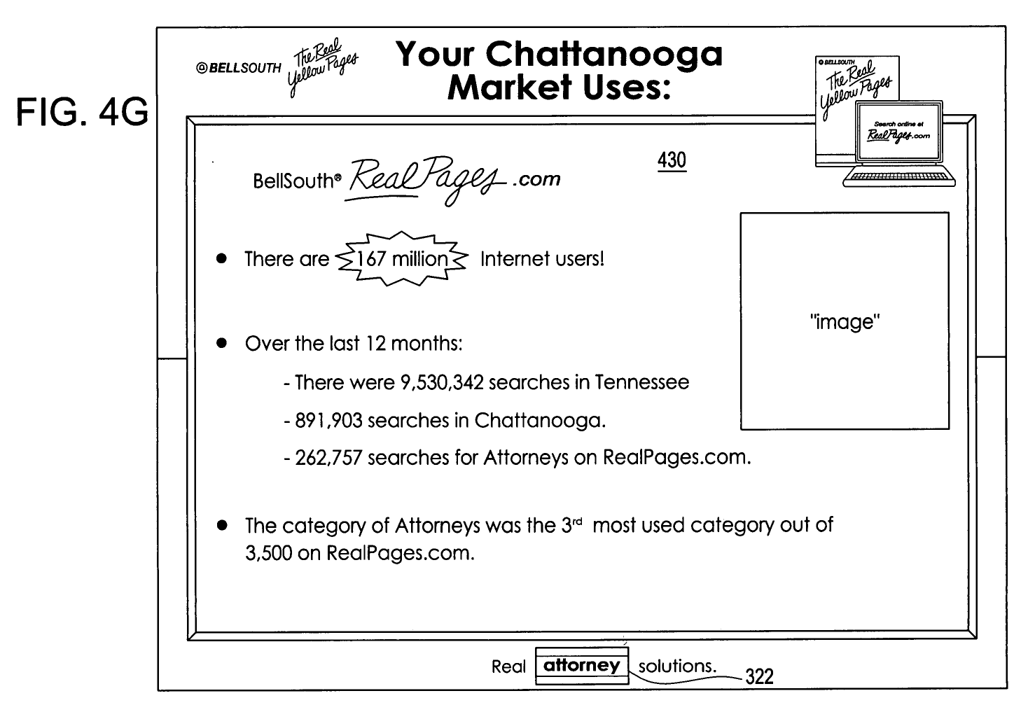

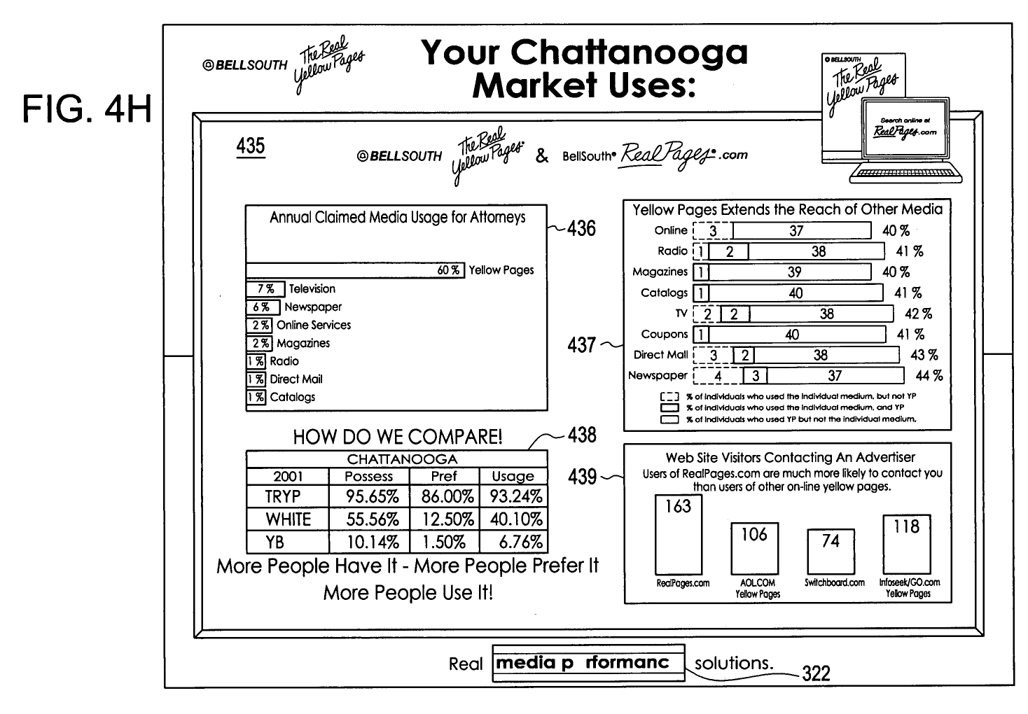

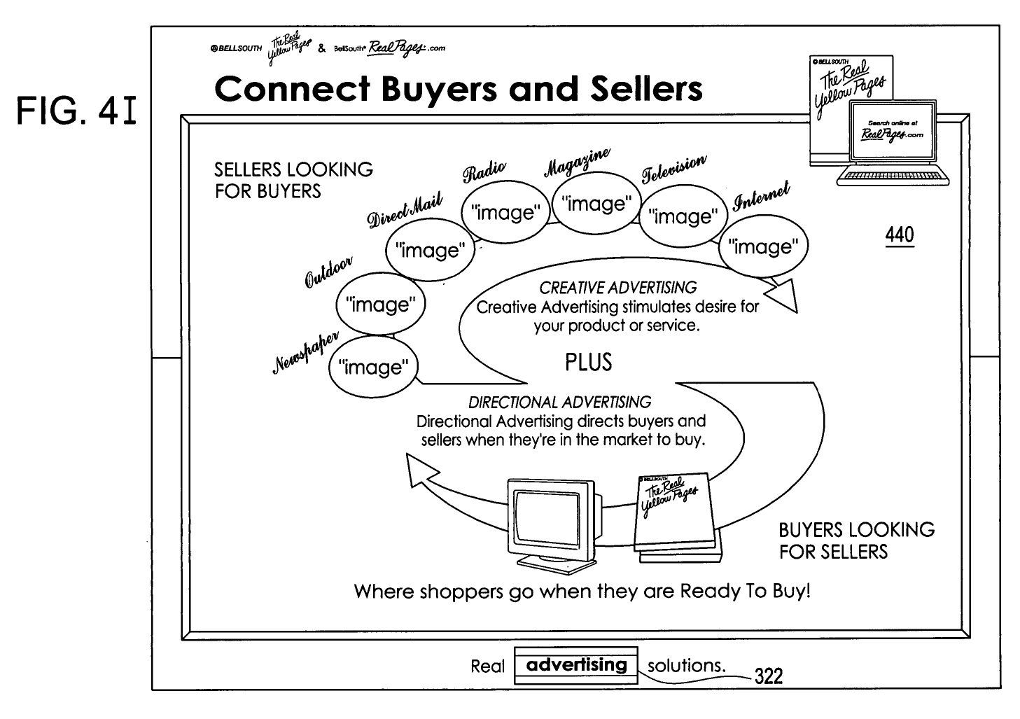

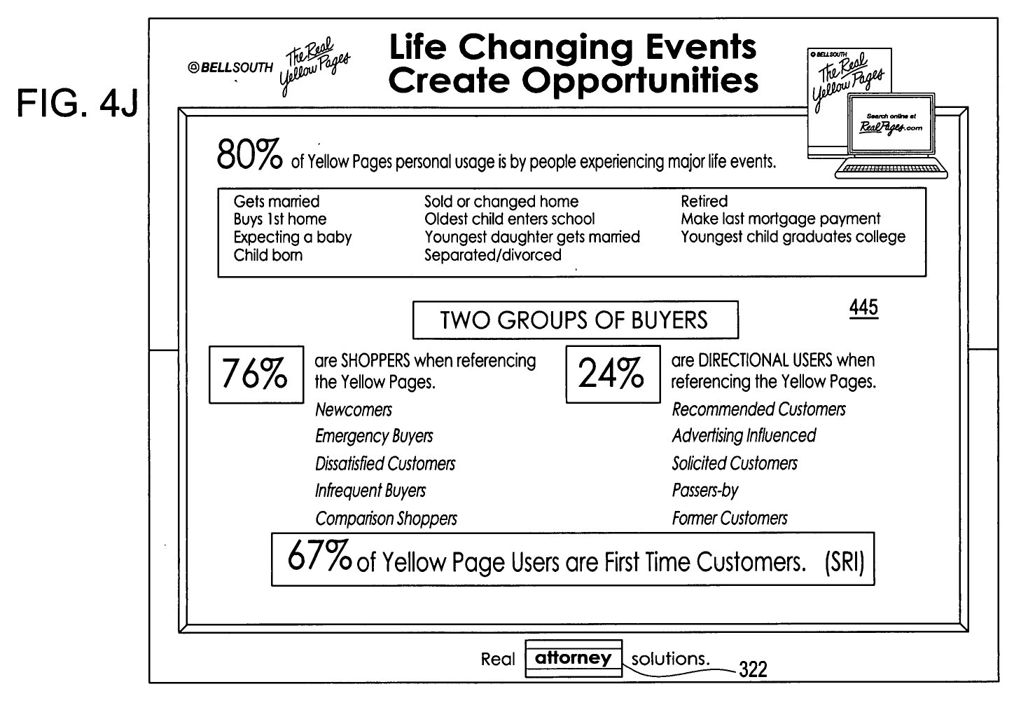

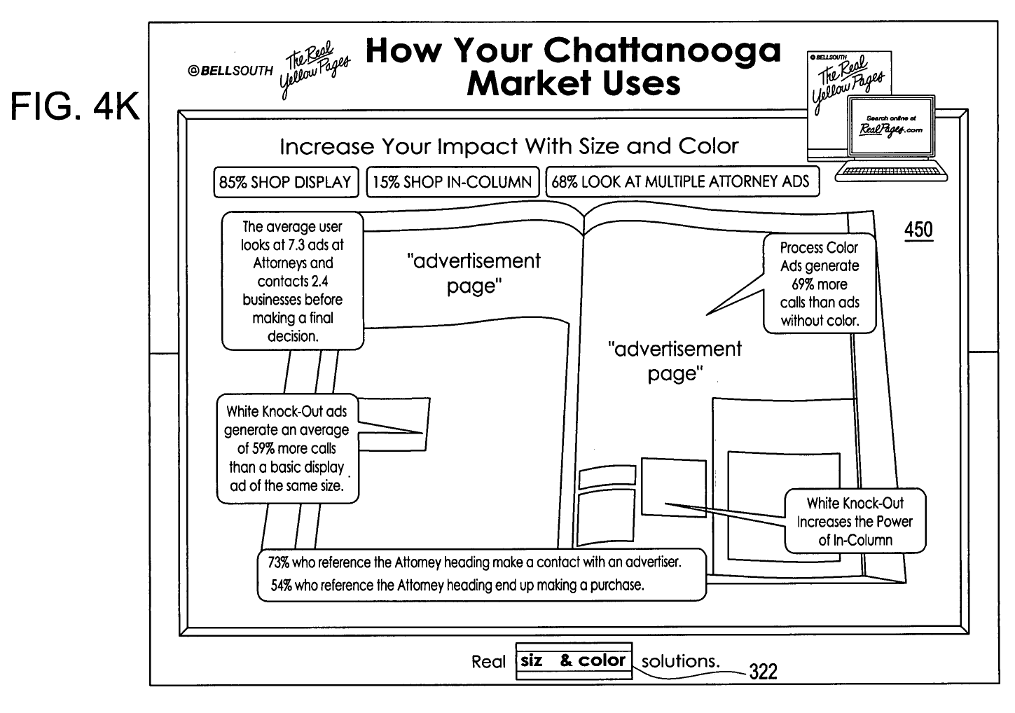

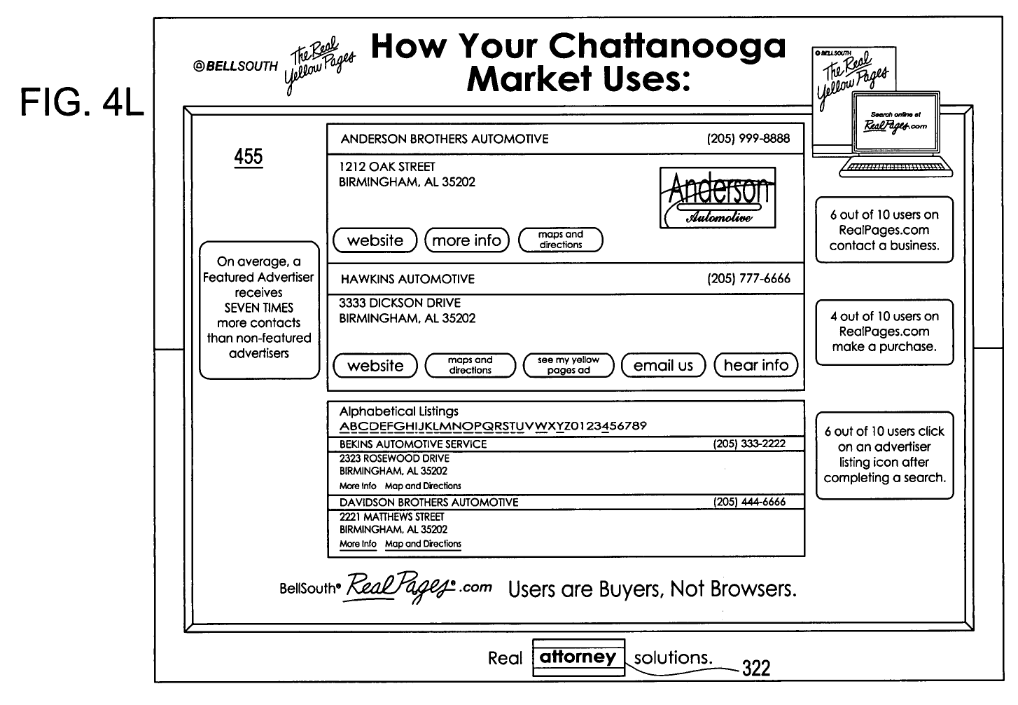

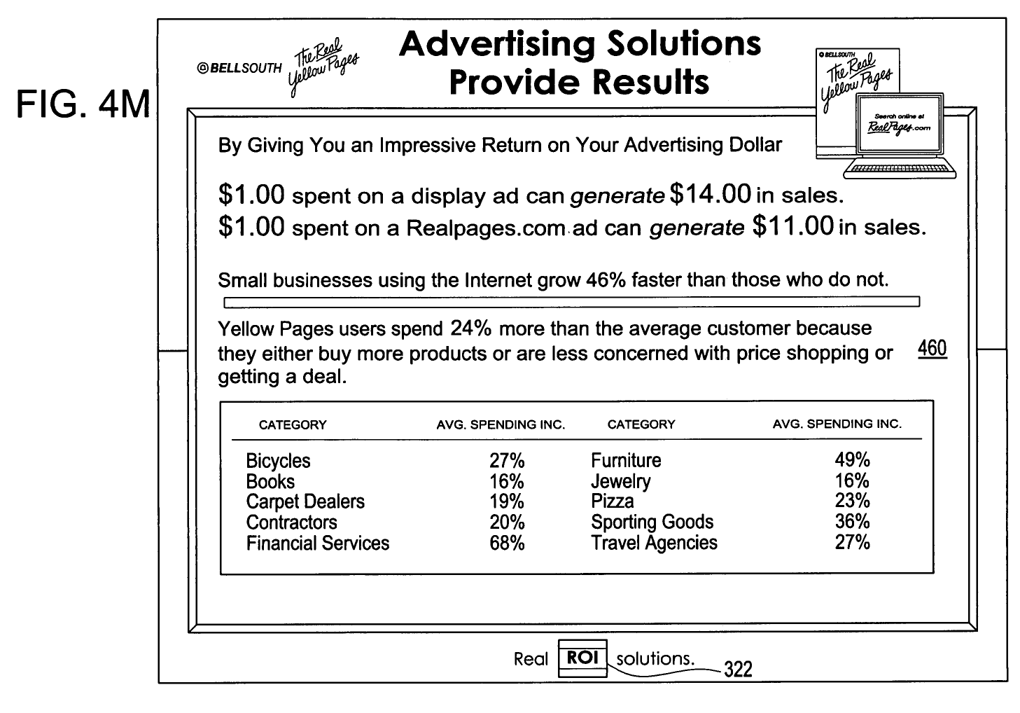

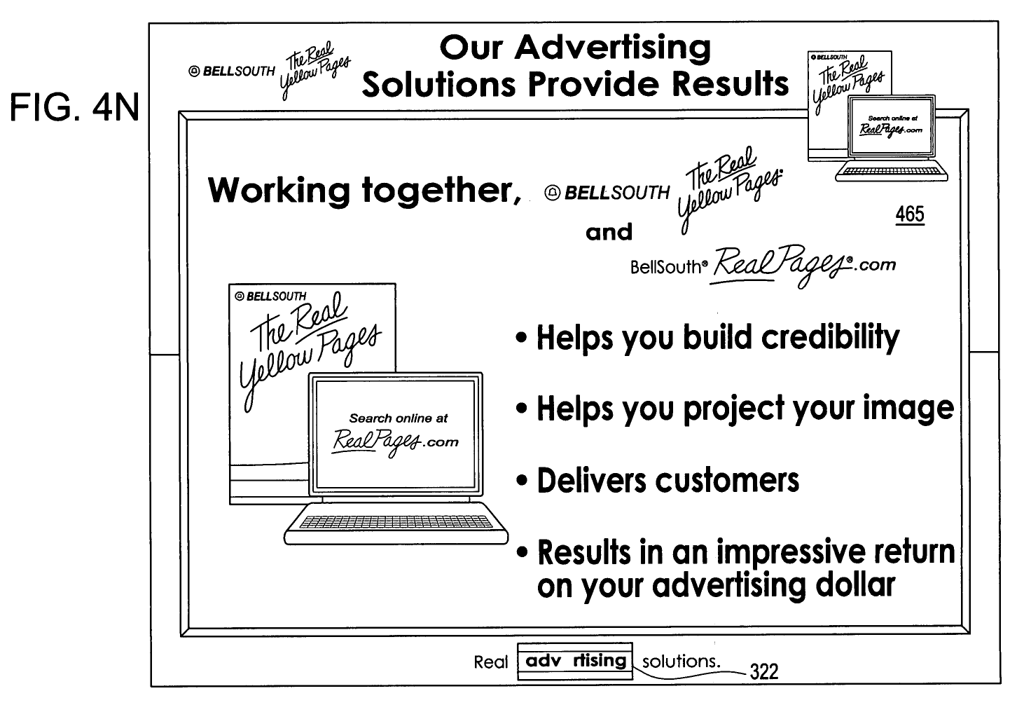

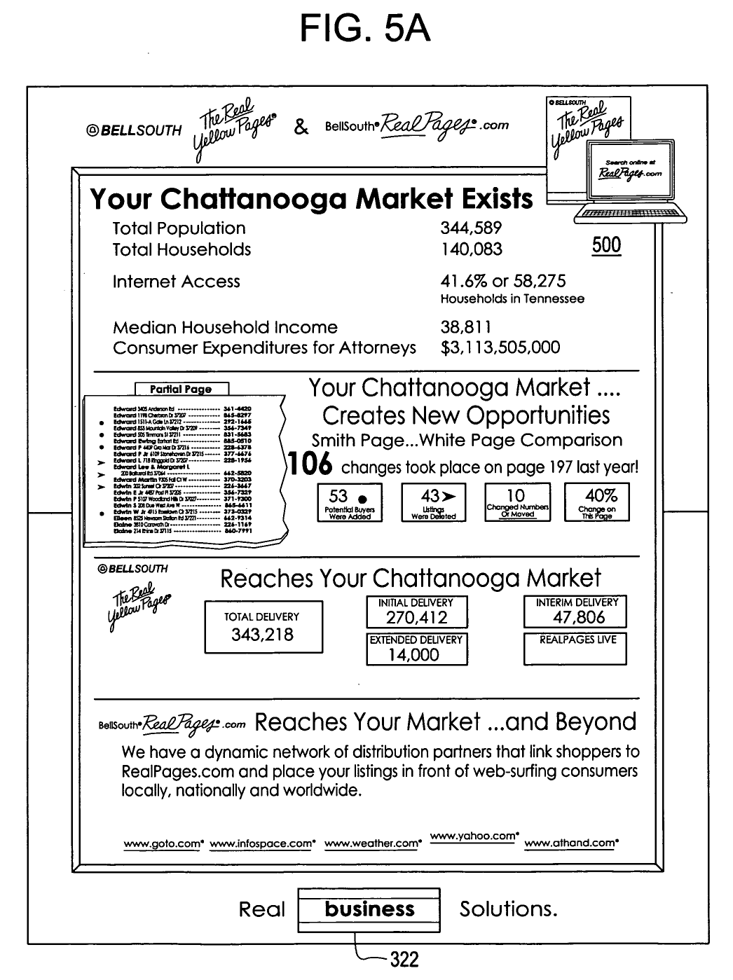

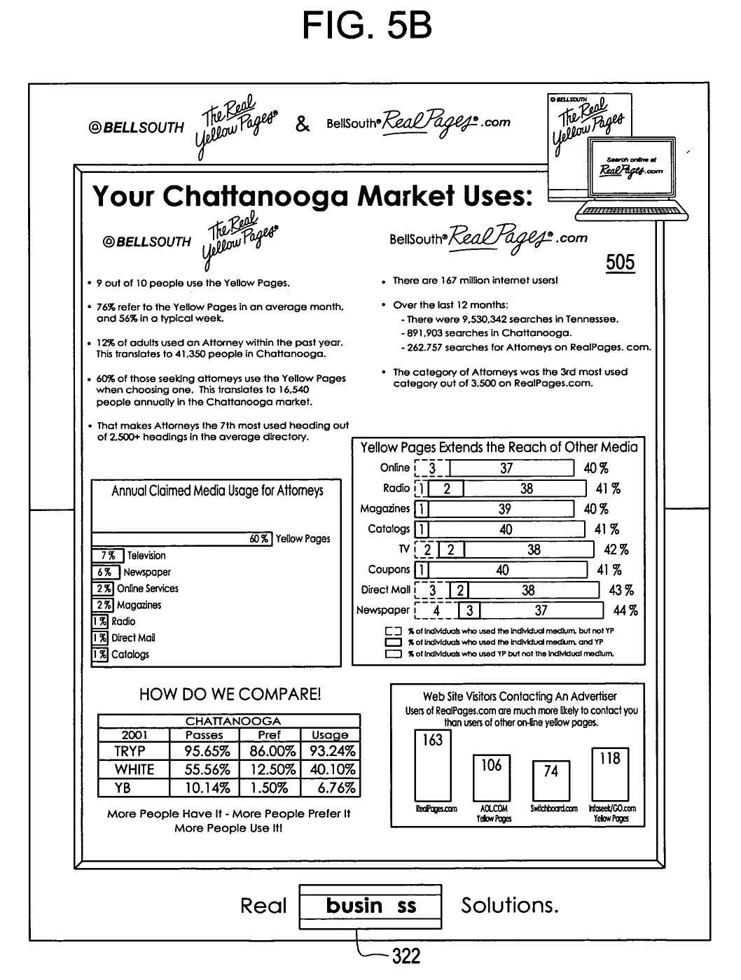

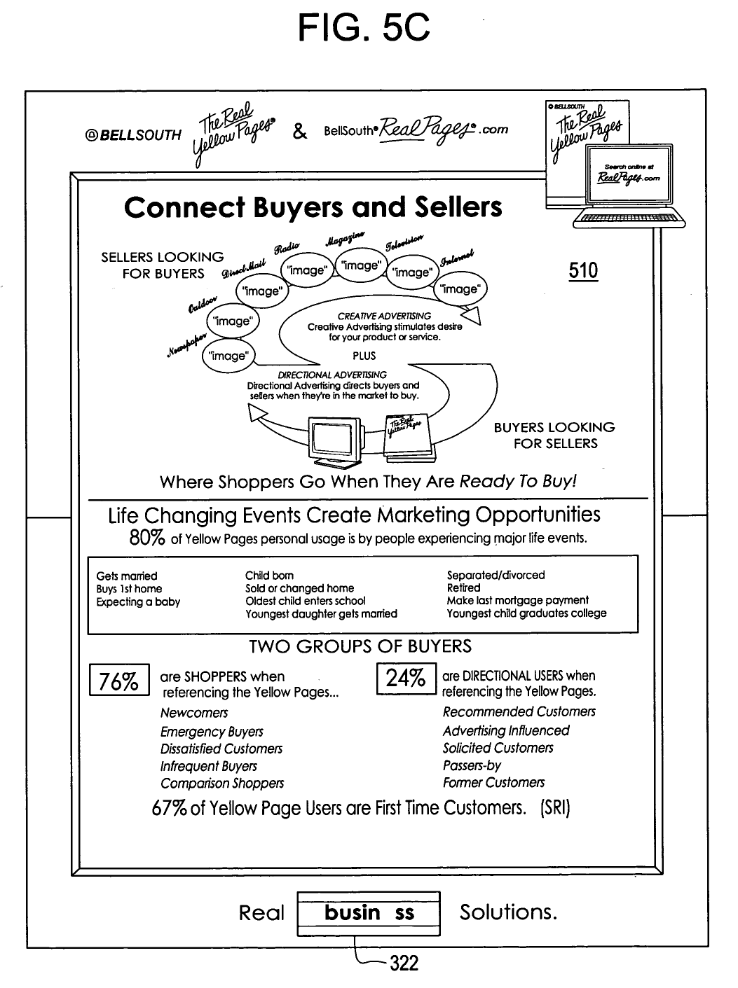

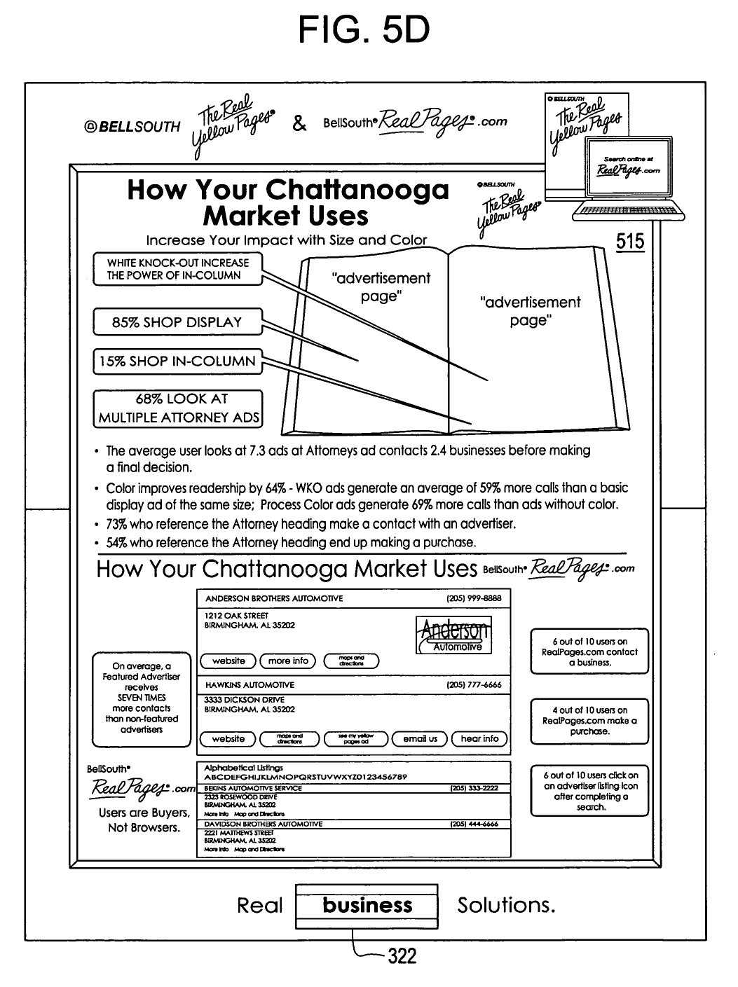

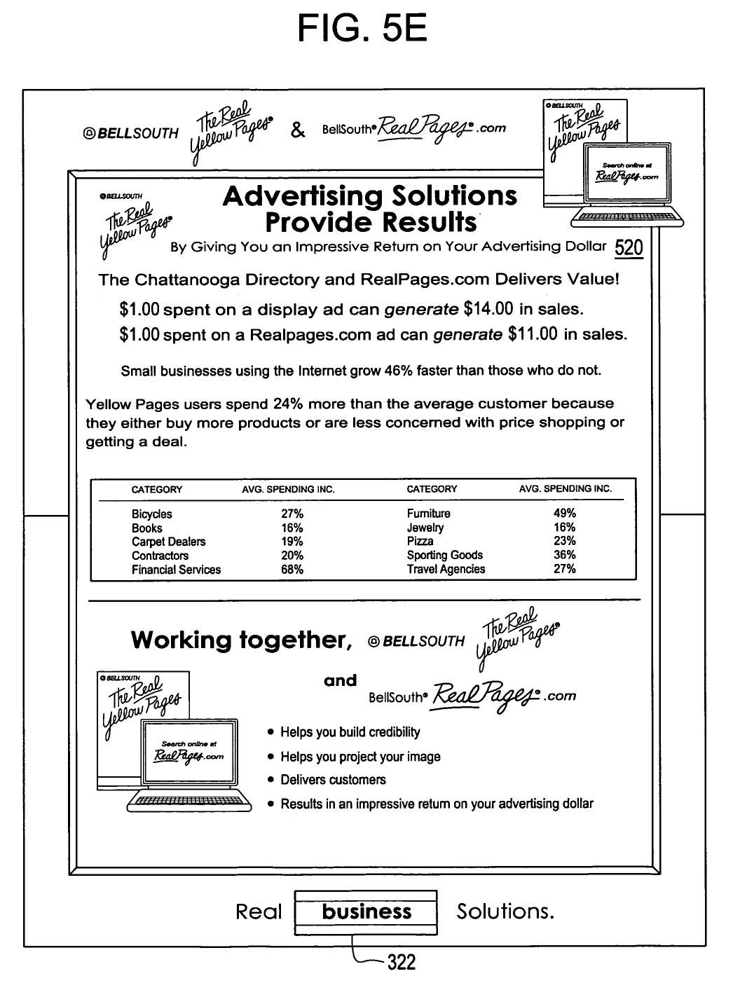

Referring to FIGS. 1-3E in combination, method 100 begins at block 110 where the user enters access information 305 into a computer 210 of computer system 200. Computer 210 is in signal communication, via physical connection 220 or Network connection 230, with a database 240 at storage device 250. Network connection 230 may be via the Internet, a local area network (LAN), a wide area network (WAN), an Ethernet connection, a wireless network, or any other network suitable for implementing embodiments of the invention. Connected to network 230 is a server 270, such as a web application server for example, which processes requests from computer 210, accesses storage device 250 and database 240, and communicates the processed results back to computer 210. In an alternative embodiment, storage device 250 may be integral with web application server 270. Access information 302 is provided at screen 301 of computer 210 and typically includes a user identification 304 and a password 306. Access to subsequent screens in method 300 is provided by the submit button 308 on screen 301. At blocks 120 and 130 and screens 311 and 321, the user enters a product identifier 312 and a sub-product identifier 322 relating to a portion of the proprietary data at database 240. The sub-product identifier relates to the product identified by the product identifier. As used herein, the term “product” is intended to refer to any kind or type of product provided to a customer, whether it be physical or non-physical in nature. For example, a physical product may be any tangible object, such as a telephone, while a non-physical product may be a service-oriented action, such as a service call to install the telephone. An exemplary product identifier 312 identifies the product as telecommunication service advertising (such as The Real Yellow Pages (TRYP) and the White Pages (WHITE), for example) in a particular geographical region, such as Chattanooga, Tenn. for example. Exemplary sub-product identifiers 322 are data descriptors, such as demographic data, heading data, changing market data, delivery data, distribution data, market resource data (such as attorney data for example), media performance data, advertising data, size and color data, return on investment data, for example (see FIGS. 4A-4N and the discussion below). While the disclosed invention is depicted having specific product and sub-product identifiers 312, 322, other product and sub-product identifiers 312, 322 may be employed, such as cellular telephones (product identifier) and web-accessibility (sub-product identifier) for example. Examples of product and sub-product identifiers are discussed specifically in reference to FIGS. 3A-5E. At block 140 the user enters an action 350, such as “generate report” for example, into computer 210 that instructs computer 210 to perform a desired action. For example, with a generate report action 350, computer 210 sends the request to web application server 270 via network 230, application code in accordance with an embodiment of the invention running on web application server 270 accesses database 240 at storage device 250 for data relating to the product and sub-product identifiers, retrieves that data and integrates it with template report forms to generate a report therefrom. Exemplary reports are depicted in FIGS. 4A-4N and 5A-5E, which are discussed in more detail below. Computer 210 then retrieves 150 the requested data from database 240 and displays 160 the data in a pre-defined format that is also in a finished form, as depicted in FIGS. 4A-4N and 5A-5E and discussed below. In an alternative embodiment, server 270 performs all functions requested by computer 210, such as retrieving 150 the requested data from database 240 and generating the presentations depicted in FIGS. 4A-4N and 5A-5E in the pre-defined format and finished form, while computer 210 is responsive to server 270 for displaying 160 the presentations. As used herein, finished form means that the displayed data is the data of interest and is not intermediate data used in subsequent data gathering. For example, after a query in a known Internet search engine, the search engine generally provides a results screen that has an intermediate level of information, with linked pages for example. This intermediate data screen is then used as a stepping-stone for gathering additional information, by clicking on a link for example. In comparison, the invention disclosed herein provides a results screen that contains data in its finished form, that is, the results screen is not used primarily as a stepping stone for gathering additional information. While some areas of the results screen may include links to other screens (Internet pages for example), the results screen itself is primarily used for displaying the actual data of interest, in a finished form.

Referring now to FIGS. 3A-3E, method 300 is depicted having screens 301, 311, 321, 331, and 341. Elements common to more than one screen include actions 350, links 360 and tabs 370. Actions 350 are generally predefined actions performed by computer 210 in response to user inputs. In an alternative embodiment, computer 210 is utilized as an input/output device that communications the requested actions 350 to server 270, which performs the requested actions and communicates the results back to computer 210. Exemplary actions 350 include compute account value, generate account report, save account profile, and clear account profile. Links 360 are generally network links to software applications for managing or accessing an account. Exemplary links 360 include hyperlinks to pages containing Marketing information or pages containing Pricing information. Other hyperlinks may be employed as appropriate. Tabs 370 are generally local links to user input screens for managing access to an account. Exemplary tabs 370 include an Account History screen, a Presentations screen, a Sales Visuals screen, and a ROAD (Return On Advertising Dollar)/iROAD (Return On Internet Advertising Dollar) screen, for example. While the present invention is depicted having specific actions 350, links 360, and tabs 370, it will be appreciated that other or different actions, links and tabs may be employed.

The Account History screen, depicted at 311, generates a recommendation worksheet combined with customer and market specific information, which may include: product, publication directory, and year information; account contact name, address, telephone and facsimile numbers; complaint and adjustment information; non-pay balance and collector information; BOTS (Book On The Street) information; EACD (Early Advertising Close Date), BOC (Book Close), LSD (Last Sales Day), and EBD dates (Effective Bill Dates); LEC (Local Exchange Carrier) indicator information; heading tier (sub-product identifier) information; a field to populate the page number and the customer's position on the page; a field to populate the number of display ads and the largest ad size at the specified heading; a recommendation worksheet, dominant proposal, and competitive proposal; BOTS UDACS (as used herein, udacs (universal directory advertising codes) are codes used to order items), billing agent, and NYPS (National Yellow Page Supplier); and, a 3 year account history, for example. Included on screen 311 is an account directory 314 containing nested folders of account information, customer information fields 316 for inputting a customer identifier and name, and a download listing 318 that identifies files to be downloaded to computer 210.

The Presentation screen, depicted at 321, generates a market specific (product identifier 312) and heading specific (sub-product identifier 322) presentation, discussed in more detail below in reference to FIGS. 4A-4N and 5A-5E. The presentation includes data relating to the region of interest, such as: population; number of households; Internet access; median household income; consumer expenditures; telephone white page comparison; distribution; usage figures for specific products (telephone yellow pages either in print or electronic format); heading (sub-product) and category (sub-sub-product) ranking; number of Internet users; media usage (AIM (Active Intermedia)); YP (Yellow Page) Extends The Reach (AIM) (a study that shows YP usage compared to other medias); comparison of competitive products; life changing events; identification of buyers; ad layout comparison; number of ads viewed; percentage of people making contact; percentage of people making purchase; size, color, and content of ad; featured versus alphabetical format comparison; impressive return information; and, dollars spent by users of products, for example, where the data is presented in a format that drives the sales presentation in a way that best serves the business. Included on screen 321 is a placeholder for sub-sub-product identifiers 324 (such as Internet categories for example), a directory of presentations 326, and a marketing channel identifier 328. Marketing channel identifier 328 drives the selection of a fourteen-page presentation or a five-page presentation, as will be discussed below in reference to FIGS. 4A-4N and 5A-5E.

The Sales Visuals screen, depicted at 331, generates a list of products offered in that particular market, and corresponding visuals to support those products. Included on screen 331 is: a visuals directory 332 for providing supporting collateral outside the presentation slides for example), which contains, for example, Discovery/Fact Finding, Recommendation, Overcoming Objections, and Close, subfolders; a selection of Internet visuals 334 in a scroll down menu; and, a selection of specialty visuals 336 in a scroll down menu. Visuals directory 332 may contain many files, such as 1,000 for example.

The Discovery/Fact Finding folder in visuals directory 332 may include such files as: a CNA form (Customer Needs Assessment); and, Profile America information, which may include about 100 headings and an alphabetical search option.

The Recommendation folder at 332 may include sub-folders relating to: Ad Size, Color, and Content; Ad Design; White Pages Content; Tools; and, Features and Benefits, for example. The Ad Size, Color, and Content sub-folder may include files relating to: 4 bases of ad design; applicant contact information; format information; impact of color; and, examples. The Ad Design sub-folder may include files relating to: comparative ad analysis; and 4 bases of ad design. The White Pages sub-folder may include files relating to: basic visuals; and, functional listing information. The Tools sub-folder may include files relating to specific worksheets. The Features and Benefits sub-folder may include files relating to specific products.

The Overcoming Objections folder at 332 may be organized in subfolders by the type of objection that may be received from a potential customer. Each sub-folder contains sales visuals to overcome that particular objection, and may also contain process information for overcoming an objection. Exemplary types of objections include: cost; usage; established recognition; economy; established customer base; competition; ad size; business conditions; and, trends, for example.

The Close folder at 332 may include files relating to account finalization and closure.

The ROAD/iROAD screen, depicted at 341, provides a means for computing the return on advertising dollar for either ROAD or iROAD using selector 342 a calculator 344. Calculator 344 may include information relating to: UDAC (define acronym); number of calls per month (data provided by market forecast); number of calls per year (calculated); percentage of new customers (data provided by market forecast); number of new customers (calculated); number of new customers sold (data provided by market forecast or calculated from database information); percentage of new customers referred by customers sold (data provided by market forecast); and, total of new customers (calculated), for example. Optionally, calculator 344 may include information relating to: the number of purchases each customer makes in a year; the total of those purchases for all new customers; the revenue generated by customer worth and total purchases; the cost of advertising; the actual return on advertising dollar; and, the return ratio. In an embodiment, screen 341 includes ROAD directory 346 containing nested folders of specific account information relating to the return on advertising dollars for those accounts.

Referring now to FIGS. 4A-4N and 5A-5E, fourteen-page and five-page presentations are depicted, respectively. The selection of which being determined by marketing channel identifier 328 and the Generate action 350. If the Prem (Premise) radio button is selected for identifier 328, then a fourteen-page presentation is generated (FIGS. 4A-4N) having screens or presentation slides depicted by 400, 405, 410, 415, 420, 425, 430, 435, 440, 445, 450, 455, 460, and 465, respectively. If the Telephone radio button is selected for identifier 328, then a black and white emailable and faxable five-page presentation is generated (FIGS. 5A-5E) having screens or presentation slides depicted by 500, 505, 510, 515, and 520, respectively. In an alternative embodiment, the five-page presentation (FIGS. 5A-5E) may be generated in color for electronic distribution, via email for example. While the information content of FIGS. 4A-4N and 5A-5E is generally the same, the layout is different, thereby providing an alternative approach to communicating information to the customer depending on the circumstances, such as whether the communication is performed in person, over the telephone, or via some other communication means. Accordingly, the discussion relating to the content of FIGS. 4A-4N is also applicable to the content of FIGS. 5A-5E. As discussed above, the information in database 240, which drives the screen content of FIGS. 4A-4N and 5A-5E, is provided by service providers compensated for the information they provide. By tailoring the presentation material in FIGS. 4A-4N and 5A-5E to a particular audience, a more effective sales presentation may be made. Here, the general product is telecommunication service advertising, and the sales presentation relates to how the advertising is used and can be used to the customers' advantage. While the described embodiment depicts telecommunication service advertising as an exemplary embodiment, it will be appreciated that the disclosed methodology is applicable to a wide range of products and customers. It will also be appreciated that the information content of the presentation is also valuable for its content alone and not solely for sales purposes, thereby providing an effective method for generating a focused analysis on a particular item from a wide range of data in a large database.

Referring now to FIGS. 4A-4N, which results from the generation of a presentation from screen 321, screen 400 identifies to the customer what the product is, which is driven by product identifier 312. Here, the product is telecommunication service advertising in the customer-based region of Chattanooga. However, it will be appreciated that the geographic region of Chattanooga is for exemplary purposes only and that other geographic regions may be substituted therefore. The order of progression through slides 400-465 is driven by computer system 200, which arranges the presentation flow in a particular order, such as: how the market exists, what the market uses are for predefined products, and how the market uses the predefined products. Thus, for any presenter in any serviced region, the look and feel of the presentation is the same, with the primary change being the factual content (here, numerical data). On each screen, the sub-product identifier 322 is shown, thereby providing the customer with an overview of what the content of the screen relates to.

At screen 405 (how the market exists), the customer is provided with demographic information (sub-product identifier 322) relating to the region defined by product identifier 312. Information is provided for years 2002 and 2007, thereby providing comparative and statistical information relating to market changes, for the particular region identified. While exemplary years are depicted as 2002 and 2007, it will be appreciated that information relating to any two, or more, years may be displayed. Screen 410 provides information relating to the changing market for the particular product of interest. Here, telephone white pages advertising in Chattanooga saw 106 changes on page 197 in a particular year. Screen 415 provides information relating to the product reach within the market, showing how different modes of product delivery are geographically distributed, and screen 420 provides information relating to the market players in the region of interest. For an alternative product and sub-product combination, such as cellular telephones and web-accessibility for example, screen 420 may show what competitors are active within a particular region of the market.

At screen 425 (what the market uses are), the customer is provided with information relating to a particular market resource, such as attorneys for example, and how attorneys impact the advertising in Chattanooga. It will be appreciated that attorneys is just one example of a market resource and that other market resources, such as florists for example, may be substituted for attorneys. Screen 430 provides information relating to particular market uses, such as Internet use and search use for example, with attorney data, sub-product identifier 322, being included to show market impact. Screen 435 provides comparative information relating to market uses for advertising. For example: one block 436 of comparative information relates the product (telecommunication service advertising) in the yellow pages to other advertising media; another block 437 shows how the product (particularly the yellow pages) can improve upon the other advertising media; a third block 438 provides information relating various products (the real yellow pages (TRYP), the white pages (WHITE), and the yellow book (YB)) and the percentage of the regional population that possesses, prefers, and uses those products; and, a fourth block 439 provides a competitive comparison relating to a particular advertising product.

At screen 440 (how the market uses), the customer is provided with general information relating to how the market uses advertising. An optional embodiment includes hyperlinks on each form of advertisement, newspaper for example, that provides access to more detailed information relating to that form of advertisement. Screen 445 provides the customer with information relating to changing events and how the market uses advertising in relation to major life events. Screen 450 provides the customer with information relating to the size and color sub-product identifier 322 and how the size and color of an advertisement can impact the decision of the end user. Screen 455 provides further information relating to the visual impact of an advertisement. Screen 460 provides the customer with information relating to how the product can impact the customer's return on investment (ROI), with specific categories of advertisements being highlighted. Screen 465 closes the presentation with a general overview of how the product can benefit the customer.

FIGS. 5A-5E, as discussed above, provides a more compact version of the data presented in FIGS. 4A-4N, with some data, such as the second year data shown on screen 405 being eliminated for compactness. As can be seen by comparing the illustrated factual content (here, numerical data) of FIGS. 4A-4N (screens discussed above) with FIGS. 5A-5E (screens 500, 505, 510, 515, and 520), it can be seen that the same numerical data is present in both figures, but in different layouts.

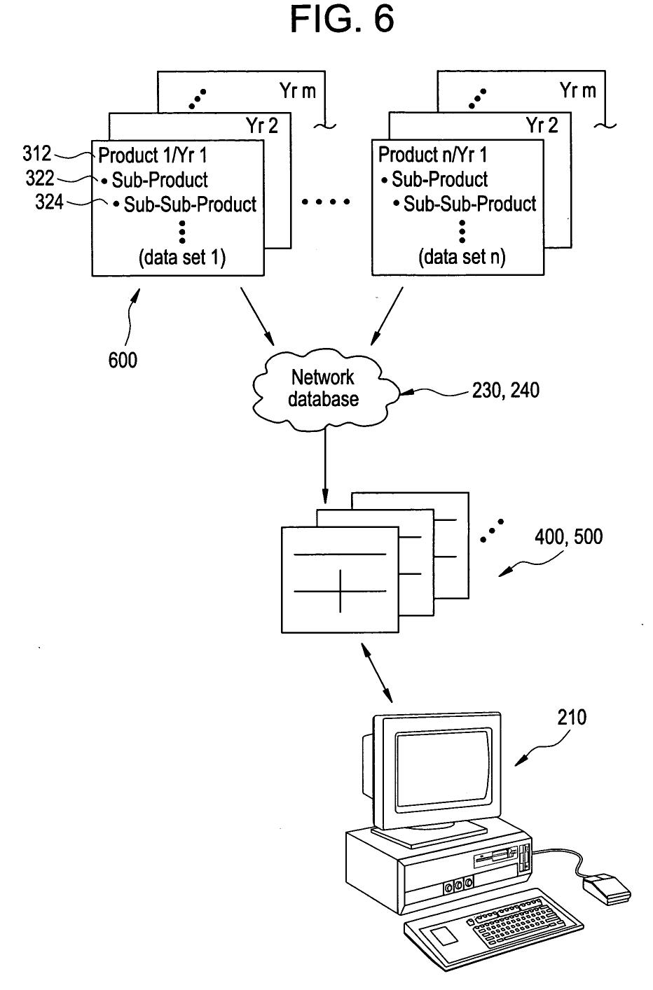

Referring now to FIG. 6, which depicts the general flow of data into and out of a network database 230, 240 and server 270, accumulated information 600 relating to Product-1 through Product-n is provided by a service provider and input into database 240 via a network 230 access or other suitable means, such as an upload from a CD-ROM for example. The service provider provides factual data relating to product, sub-product, and sub-sub-product identifiers 312, 322, 324, for different products (here, Product-1 is advertising in Chattanooga, and Product-n is advertising in another geographical region) and for different years (Year-1, Year-2 through Year-m), which is stored in database 240 in a predefined structured arrangement, with each product having different data sets arranged in a similar format. Application code in accordance with embodiments of the invention running on computer system 200, and specifically on web application server 270, enables a user, such as a sales representative for example, to access database 240 via computer 210 in the manner discussed above in reference to FIGS. 3A-3E, and to display one of two predefined presentation formats containing the desired data in finished form, as depicted in FIGS. 4A-4N and 5A-5E. As discussed above, web application server 270, upon receiving a request from computer 210 via network 230, accesses database 240 at storage device 250 for data relating to the user defined request, retrieves that data, integrates it with template report forms 400, 500, for example, and generates a report therefrom (FIGS. 4A-4N and 5A-5E).

While embodiments of the invention have been described having two predefined presentation formats, as illustrated in FIGS. 4A-4N and 5A-5E, it will be appreciated that other predefined presentation formats may also be employed. For example, a third predefined presentation format may include a subset of the data included in either of the first two formats with the addition of further data, such as competitive analysis data, possession data, usage data, and preference data, for example. Here, the third predefined presentation format may include a variety of charts and graphs to indicate comparisons and trends. As a further example, a fourth predefined presentation format may include data relating to local market facts and characteristics, which in turn may drive unique goods and services headings in the presentation relating to that particular local market. For example, a first market may have unique tourist attraction characteristics, a second market may have unique waterway or coastal characteristics, a third market may have unique occupational opportunity characteristics, and a fourth market may have unique demographic characteristics, to name a few. Here, the data for the fourth predefined presentation may be obtained by server 270 accessing a Chamber of Commerce database for the local market. Accordingly, embodiments of the invention are not limited to the predefined presentation formats depicted in FIGS. 4A-4N and 5A-5E, but may encompass other presentation formats that are predefined, generated at server 270, and communicated to computer 210 in a finished form for subsequent display.

Embodiments of the invention may be provided in executable instruction form on a storage medium, such as memory 202 in the form of a CD-ROM for example, that is readable by a processing circuit, such as processor 204 for example, the processing circuit 204 being in signal communication via application software with a graphical user interface at a computer, such as computer 210 for example, whereby a user may execute the embedded instructions for practicing the disclosed invention. The technical effect of the executable instructions is to retrieve and display proprietary and non-proprietary data relating to an offered product in a geographical area of interest in a finished form for the purpose of communicating a substantial amount of information in a readily comprehensible format.

Embodiments of the invention may have some of the following advantages: standard presentation format across geographic lines; integrated Internet and print story (presentation); improved caliber and process of strategic preparation and planning; standard coaching methodology; elimination of need to synchronize presentations; ability to track usage; the maintaining of collateral as new, exciting, and current with consistent business look and feel; ability to create uniform sales kits; availability of multiple year histories and trends; the maintaining of up-to-date ROAD/iROAD model data with calculations that are sales and customer friendly; availability of desktop ROAD/iROAD applications for onsite interaction; standardized methodology for generating visuals; the updating of single point database provides simultaneous updates to all users; a networked arrangement that provides concurrent access; the provision of a simplistic data gathering methodology with data feed into a changeable pre-formatted presentation template; the provision of a centralized database for relevant account and market data; the consolidation of data from individual files and the avoidance of manual refilling of individual templates; the provision of a pre-defined product matrix that informs the sales representative of specialty products available to certain markets, and the provision of the visuals to support that information; providing the integration of non-proprietary data with proprietary account information; providing an integrated return on investment calculator; providing an automated sales presentation output; providing Internet access to up-to-date data; and the systematic streamlining of sales visuals for a broad audience.

While the invention has been described with reference to exemplary embodiments, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the appended claims. Moreover, the use of the terms first, second, etc. do not denote any order or importance, but rather the terms first, second, etc. are used to distinguish one element from another. Furthermore, the use of the terms a, an, etc. do not denote a limitation of quantity, but rather denote the presence of at least one of the referenced item.

What is claimed is:

1. A computer program product, the product having a storage medium, readable by a processing circuit, storing instructions for execution by the processing circuit for:
responding to user access information for accessing data at a database, responding to a product identifier relating to the data at the database, and responding to a command for accessing the database for data relating to the product identifier;
accessing and retrieving from the database, data relating to the product identifier;
responding to a command for generating a presentation in one of at least two pre-defined formats; and
displaying the retrieved data in the one of at least two pre-defined formats and in a finished form.

2. The product of claim 1, wherein the product identifier further comprises a sub-product identifier relating to the identified product.

3. The product of claim 2, wherein the data in the database is at least partially proprietary data.

4. The product of claim 1, wherein the at least two pre-defined formats includes a first format and a second format, the second format being a condensed version of the first format.

5. The product of claim 4, wherein the second format is arranged for black and white reproduction and/or facsimile transmission.

6. The product of claim 1, further comprising instructions for execution by the processing circuit for:
accessing and retrieving a first set of data relating to a first product identifier and displaying the first set of data in the pre-defined format; and
accessing and retrieving a second set of data relating to a second product identifier and displaying the second set of data in the same pre-defined format.

7. The product of claim 3, further comprising instructions for execution by the processing circuit for:
receiving proprietary data from a service provider, the data relating to the product identifier and sub-product identifier; and
storing the data at the database for subsequent access and retrieval.

8. The product of claim 7, wherein:
the product identifier relates to advertising in a particular geographic region; and
the sub-product identifier relates to demographic data, heading data, changing market data, delivery data, distribution data, market resource data, media performance data, advertising data, size and color data, return on investment data, or any combination of data comprising at least one of the foregoing.

9. The product of claim 1, wherein the accessing and retrieving comprises:
accessing and retrieving from the database and via the Internet, data relating to the product identifier.

10. The product of claim 1, wherein the at least two pre-defined formats includes a first format and a third format, the third format being at least a partial subset of the first format.

11. The product of claim 10, wherein the third format further includes data relating to competitive analysis data, possession data, usage data, preference data, or any combination of data comprising at least one of the foregoing.

12. The product of claim 1, wherein the at least two pre-defined formats includes a first format and a fourth format, the fourth format including data unique to facts and characteristics of a particular local market.

13. A method for acquiring data from a database, comprising:
responding to user access information for accessing data at a database, responding to a product identifier relating to the data at the database, and responding to a command for accessing the database for data relating to the product identifier;
accessing and retrieving from the database and via the Internet, data relating to the product identifier;
responding to a command for generating a presentation in one of at least two pre-defined formats; and
displaying the retrieved data in the one of at least two pre-defined formats and in a finished form.

14. The method of claim 13, wherein the product identifier further comprises a sub-product identifier relating to the identified product.

15. The method of claim 14, wherein the data in the database is at least partially proprietary data.

16. The method of claim 13, wherein the at least two pre-defined formats includes a first format and a second format, the second format being a condensed version of the first format.

17. The method of claim 16, wherein the second format is arranged for black and white reproduction and/or facsimile transmission.

18. The method of claim 13, wherein the accessing, retrieving and displaying further comprises:
accessing and retrieving a first set of data relating to a first product identifier and displaying the first set of data in the one of at least two pre-defined formats; and
accessing and retrieving a second set of data relating to a second product identifier and displaying the second set of data in the same one of at least two predefined formats.

19. The method of claim 15, further comprising:
receiving proprietary data from a service provider, the data relating to the product identifier and sub-product identifier; and
storing the data at the database for subsequent access and retrieval.

20. The method of claim 19, wherein:
the product identifier relates to advertising in a particular geographic region; and
the sub-product identifier relates to demographic data, heading data, changing market data, delivery data, distribution data, market resource data, media performance data, advertising data, size and color data, return on investment data, or any combination of data comprising at least one of the foregoing.
